(19) United States
(12) Patent Application Publication
(10) Pub. No.: US 2012/0324156 A1
(43) Pub. Date: Dec. 20, 2012

(54) METHOD AND SYSTEM OF ORGANIZING A HETEROGENEOUS MEMORY ARCHITECTURE

(76) Inventors: Naveen Muralimanohar, Santa Clara, CA (US); Aniruddha Nagendran Udipi, Salt Lake City, UT (US); Norman Paul Jouppi, Palo Alto, CA (US)

(21) Appl. No.: 13/162,946

(22) Filed: Jun. 17, 2011

(51) Int. Cl. G06F 12/02; G06F 12/16

(52) U.S. Cl. 711/104; 711/114; 711/E12.008; 711/E12.103

(57) ABSTRACT

An exemplary embodiment of the present invention may build data blocks in non-volatile memory. The corresponding parity blocks may be built in a fast, high endurance memory.

### BACKGROUND

Parity is used in many hardware applications, such as small computer system interfaces (SCSI) and various redundant array of independent disk (RAID) levels. Parity bits may detect error and ensure data integrity. Often, a parity bit is a single bit added to the end of a data block. Parity bits may change based on the type of parity used. When used with RAID schemes, parity bits can assist in reconstructing missing data in the event of a system failure. While parity operations frequently occur on non-volatile devices with limited write endurance, parity protection is write intensive.

### BRIEF DESCRIPTION OF THE DRAWINGS

Certain exemplary embodiments are described in the following detailed description and in reference to the drawings, in which:

FIG. 1 is a process flow diagram showing a method of organizing a heterogeneous memory architecture according to an embodiment;

FIG. 2 is a process flow diagram showing a method of organizing a heterogeneous memory architecture according to an embodiment;

FIG. 3 is a block diagram of a memory system in a heterogeneous organization according to an embodiment of the present techniques;

FIG. 4 is a block diagram of a memory system in a heterogeneous organization with a dedicated protection for storage according to an embodiment of the present techniques;

FIG. 5 is a block diagram of a system that may organize a heterogeneous memory architecture according to an embodiment; and

FIG. 6 is a block diagram showing a non-transitory, computer-readable medium that stores code for organizing a heterogeneous memory architecture according to an embodiment.

### DETAILED DESCRIPTION

When a data message is transmitted between devices, the data is generally accepted as correct when no parity bits or error correcting code is used. However, unreliable communication paths between the source device and the receiving device, as well as noise in the transmission, may contribute to error in the message. Moreover, the failure of storage arrays or other system components may contribute to error in the message. Parity bits may be used as a check for error in the corresponding data block by adding a single bit to the end of a data block to make the sum of bits in the entire message either even or odd. Thereby, when even parity is used, the receiving device may detect error in the transmission if the bits of the message do not sum to an even number. Likewise, when odd parity is used, the receiving device may detect error in the transmission if the bits of the message do sum to an odd number.

RAID schemes are able to use parity in two levels, where a first level parity applies a parity bit and a second level parity applies another parity bit, as well as in both vertical and horizontal parity checks. Vertical parity may apply a parity bit once per X number of bits, applied across a stream of bits. Horizontal parity may be applied independently to each group of bit streams when data is divided into blocks. Certain RAID schemes, such as RAID-4 or RAID-5, use separate disk drives that contain parity information to allow the rebuild of data in the event of a device failure. RAID-4, in particular, uses a dedicated parity drive, while RAID-5 distributes parity data across all drives in the RAID group.

Data storage in a RAID scheme may occur on various memory chips, such as random access memory (RAM), which may contain specialized memory designated as data registers or cache. This specialized memory may allow faster access to data that may be originally stored on a larger storage device, such as a disk drive or a non-volatile random access memory (NVRAM). RAM, dynamic random access memory (DRAM), and static random access memory (SRAM) are considered volatile memory devices. When power is removed from volatile memory devices, the data stored on those devices is lost. Disk drives, as well as NVRAM, are considered to be non-volatile memory devices. Data is maintained on the non-volatile memory devices, even when the power is turned off.

NVRAM devices may be subject to several weaknesses, including poor write characteristics and write-endurance. When writing to NVRAM, the writes typically occur in larger blocks than some computer systems can automatically address. Writes are often slow, with several times the latency of a read operation on the same device. Additionally, NVRAM has a finite number of write and erase cycles before the integrity of data on the device may be compromised. The longevity of an NVRAM device may also be compromised when it is heavily used in a write-intensive RAID scheme. As a result, while RAID schemes may provide efficiency, the schemes may not be well suited for use with NVRAM devices.

Embodiments of the present techniques may organize a heterogeneous memory architecture. For ease of description, the present techniques may be described in the context of single bit parity. However, embodiments of the present techniques may be used with any form of error correction technique that writes some redundant information.

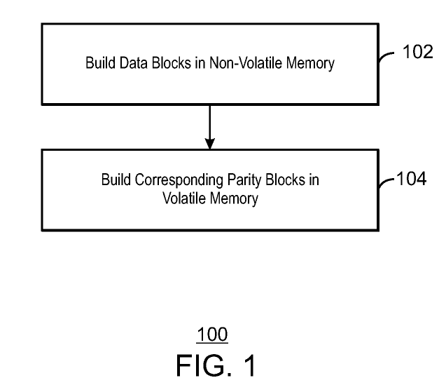

FIG. 1 is a process flow diagram showing a method 100 of organizing a heterogeneous memory architecture according to an embodiment. Heterogeneous memory layouts may be used to direct extremely write-intensive parity words to volatile memory, while retaining data words in non-volatile memory. Accordingly, at block 102, data blocks are built in non-volatile memory. At block 104, parity blocks are built corresponding to data blocks using fast, high endurance memory. Fast may refer to the speed at which data on the memory device may be accessed, while high endurance may refer to a high read and write endurance of the memory device.

Memory systems may use NVRAM technologies such as memristors or phase-change memories, as opposed to disk drives, to accommodate the large amount of memory required to store program instructions and data. Computing systems used in the operation of various businesses may demand high levels of reliability from such memory systems, including the ability to seamlessly function even when entire devices fail. A component of this high level of reliability is the ability to construct parity or error correction bits using data from various blocks. As discussed above, parity bits typically involve updating a parity bit as a check on a data block.

RAID schemes may also provide this high level of reliability with minimal energy and area overheads. In other words, the RAID schemes may use a small amount of energy and area within a computer system. However, RAID operations may be highly write intensive since every data store is accompanied by a corresponding store of some amount of redundant information, depending on the particular RAID scheme being implemented. For instance, in a RAID-4 architecture, a parity block may store redundant information relating to N other data blocks. Therefore, the parity block is subject to N times as many write operations as the data blocks, as the parity block must be written to each time a write occurs on one of the N data blocks. Furthermore, as discussed above, most non-volatile memory devices have poor write-characteristics. The poor write characteristics may lead to write latencies that are often larger than read latencies. As a result, the parity device may suffer from low throughput and become a bottleneck to efficient operation. For example, in the RAID-4 scheme, a bottleneck occurs because the parity device may handle N times as many writes as the other devices. While a RAID-5 scheme may eliminate the bottleneck problem by striping redundant information across different chips, the total number of writes to the non-volatile storage may still be doubled due to updates to parity or error correcting blocks. Additionally, the increased number of writes may use the limited number of write and erase cycles of the non-volatile storage and quickly compromise the integrity of the data stored on non-volatile storage.

As a result, storing parity information that requires frequent writes with a low number of reads on non-volatile storage such as NVRAM may be suboptimal due to the weaknesses of NVRAM. Further, the unlimited reads and long retention time benefits of NVRAM are typically underutilized in such a scenario. Moreover, the write-endurance problem can be exacerbated in a memory system where a portion of the total data storage capacity is used as “main memory” and the rest as “storage,” since different degrees of protection may be necessary depending upon the block's usage. For example, main memory devices may hold frequently accessed data and be accessed more than dedicated storage. Frequent access to a write limited device such as NVRAM may increase the likelihood of device failures.

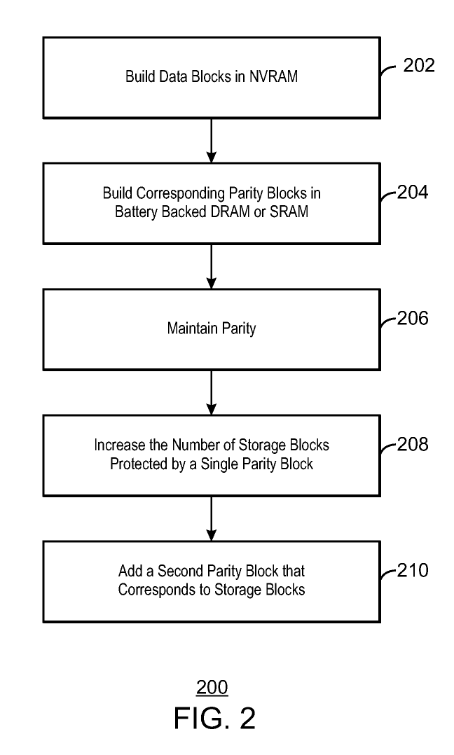

FIG. 2 is a process flow diagram showing a method 200 of organizing a heterogeneous memory architecture according to an embodiment. Data is laid out in such a way that every parity-word stores information about fewer high activity data words and more low activity data words. High activity data words may belong to main memory, while low activity data words may belong to storage. In addition, redundant information from every data word is stored in multiple parity words, allowing for transparent operation, even in the case of multiple device failure.

At block 202, data blocks are built in NVRAM. At block 204, corresponding parity blocks are built out of volatile devices such as DRAM or SRAM. The parity DRAM device may have a battery for back up power to provide an illusion of non-volatility. Consequently, every write operation may be split between the NVRAM and the DRAM. Since DRAM write operations may be significantly faster than NVRAM operations, the parity device can handle the increased load placed on it by the N data devices.

At block 206, parity is maintained, either physically or logically, such that every parity block stores information relating to a few “main memory” devices and a larger number of “storage” devices. In typical operation, one of the main memory devices is likely to wear out and fail relatively quickly due to increased usage. At this point, the possibility of data recovery is still high since the other devices corresponding to the same parity block are mostly storage devices, and thus likely less used.

To further expand the device failure coverage without significantly increasing the error protection overhead, at block 208, a greater number of storage blocks are protected with a single parity block. This first level protection spans a few memory blocks and a larger number of storage blocks. At block 210, a second parity block that corresponds to storage blocks may be added. This second level of protection may leverage the lower number of accesses seen by storage to provide protection in the event of multiple device failures while maintaining a low storage capacity overhead. The low storage capacity overhead may refer to the low amount of storage used to apply the second level of protection.

The heterogeneous memory architecture alleviates the write-inefficiency of non-volatile memory and enables the use of write-intensive RAID techniques to provide area-efficient and energy-efficient reliability. Area-efficiency may be achieved since only a small number of parity blocks may be used, corresponding to the activity levels of the data being protected. Energy-efficiency may be achieved as a result of each data access employing a limited number of devices. Further, the heterogeneous memory architecture may take advantage of faster writes when using DRAM, SRAM, or other volatile memory when compared to NVRAM writes, thereby removing a possible parity device bottleneck. Additionally, failure of the parity device early in the device life cycle may be avoided due to implementing increased writes in DRAM, SRAM, or other volatile memory. The data and parity block layout may reduce the probability of multi-device failure within a single parity-word, while a second parity block may introduce multi-dimensional parity that increases reliability in the event of multiple device failure, depending on the permissible storage and energy overhead of writing additional parity information.

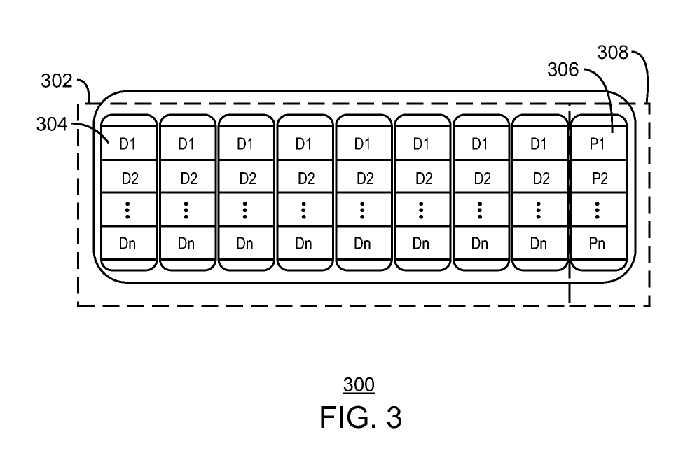

FIG. 3 is a block diagram of a memory system 300 in a heterogeneous organization. The memory system 300 includes a non-volatile memory device 302 that contains data blocks 304, which may built in a manner discussed at block 102 (FIG. 1). Data blocks 304 may be protected by the corresponding parity blocks 306, built in a manner discussed at block 104 (FIG. 1), and may be stored on a volatile memory device 308. The parity blocks 306 may provide local protection, which may be stored on the non-volatile memory device 302. Local protection typically includes parity for the bits in a single access word, and may be stored with the word itself. On every read access, this parity may be used to check for errors. The check for error may conclude that no error occurred without accessing more than one device.

In the event that the local protection check fails, the erroneous data may need to be reconstructed. Reconstructing the data may include reading N words from data blocks 304, on N devices for which parity is written on parity blocks 306, and using this information to reconstruct the erroneous data. The Nth word may correspond to the Nth row within non-volatile memory device 302.

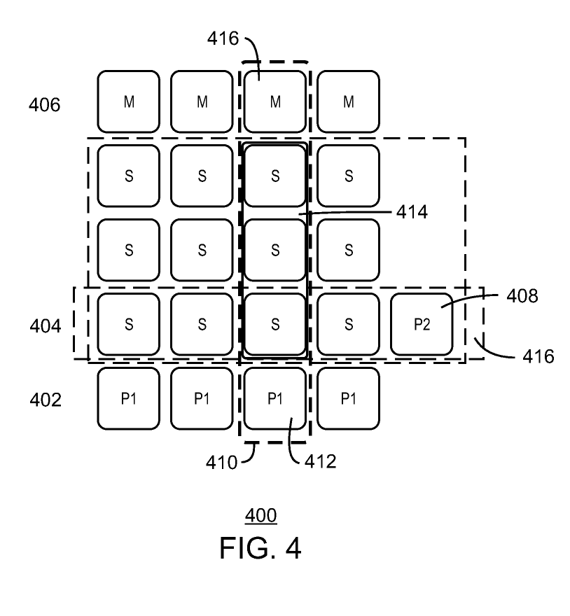

FIG. 4 is a block diagram of a memory system 400 in a heterogeneous organization with a dedicated protection for storage. Memory system 400 includes first level parity blocks 402, storage blocks 404, memory blocks 406, and a second level parity block 408. The first level parity blocks correspond to several storage blocks 404 and fewer memory blocks 406, as shown by group 410, with a parity block 412 corresponding to storage blocks 414 and a memory block 416. By protecting a greater number of low-activity storage blocks 414 with the single parity block 412, the device has failure coverage without significantly increasing the error protection overhead, as described at block 208 (FIG. 2).

A second level of protection may be added to the memory system with the addition of a parity block 408, which corresponds to a number of storage blocks 404 within group 416. The parity block 408 may leverage the lower number of accesses seen by storage to provide protection in the event of multiple device failures while maintaining a low storage capacity overhead, as described at block 210 (FIG. 2).

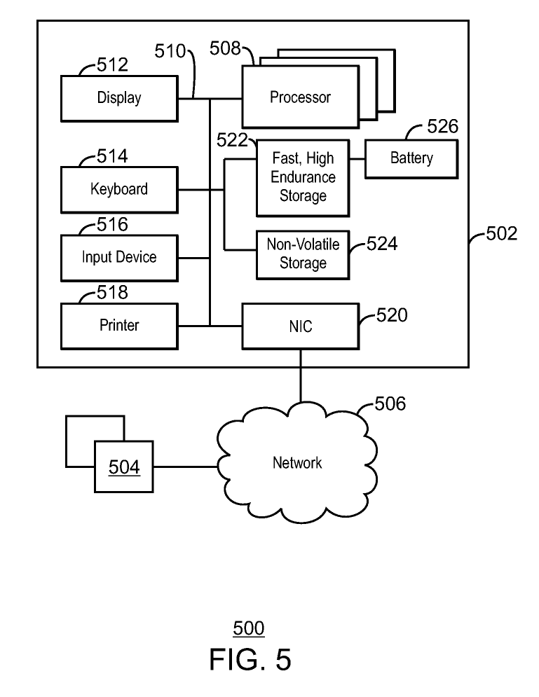

FIG. 5 is a block diagram of a system that may provide a heterogeneous memory architecture. The system is generally referred to by the reference number 500. Those of ordinary skill in the art will appreciate that the functional blocks and devices shown in FIG. 5 may comprise hardware elements including circuitry, software elements including computer code stored on a tangible, machine-readable medium, or a combination of both hardware and software elements. Additionally, the functional blocks and devices of the system 500 are but one example of functional blocks and devices that may be implemented in an embodiment. Those of ordinary skill in the art would readily be able to define specific functional blocks based on design considerations for a particular electronic device.

The system 500 may include a server 502, and one or more client computers 504, in communication over a network 506. As illustrated in FIG. 5, the server 502 may include one or more processors 508, which may be connected through a bus 510 to a display 512, a keyboard 514, one or more input devices 516, and an output device, such as a printer 518. The input devices 516 may include devices such as a mouse or touch screen. The display 512, the keyboard 514, the one or more input devices 516, and the printer 518 are not necessary for server 502 to function according to an embodiment of the invention. The processors 508 may include a single core, multiple cores, or a cluster of cores in a cloud computing architecture. The server 502 may also be connected through the bus 510 to a network interface card (NIC) 520. The NIC 520 may connect the server 502 to the network 506.

The network 506 may be a local area network (LAN), a wide area network (WAN), the Internet, or another network configuration. The network 506 may include routers, switches, modems, or any other kind of interface device used for interconnection. The network 506 may connect to several client computers 504. Through the network 506, several client computers 504 may connect to the server 502. The client computers 504 may be similarly structured as the server 502.

The server 502 may have other units operatively coupled to the processor 508 through the bus 510. These units may include tangible, machine-readable storage media, such as volatile storage 522, and non-volatile storage 524. The volatile storage 522 may include any combinations of volatile memory, such as random access memory (RAM), RAM drives, dynamic random access memory (DRAM), static random access memory (SRAM), and the like. The non-volatile storage 524 may include any combinations of non-volatile memory, such as read-only memory (ROM), flash memory, flash drives, phase-change memory, memristors, optical drives, and the like. Further, the volatile storage 522 may be backed by a battery 526. Although the battery 526 is shown to reside on the server 502, a person of ordinary skill in the art would appreciate that the battery 526 may reside outside the server 502.

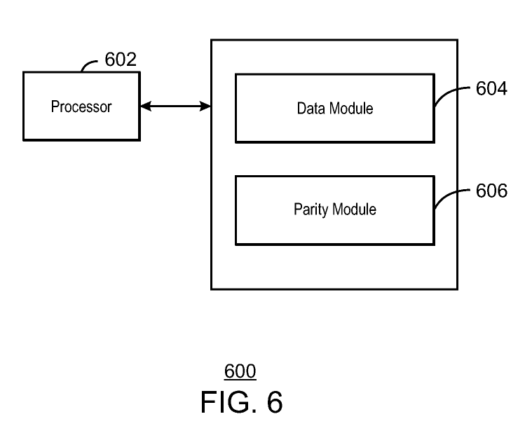

FIG. 6 is a block diagram showing a non-transitory, computer-readable medium that stores code for organizing a heterogeneous memory architecture. The non-transitory, computer-readable medium is generally referred to by the reference number 600.

The non-transitory, computer-readable medium 600 may correspond to any typical storage device that stores computer-implemented instructions, such as programming code or the like. For example, the non-transitory, computer-readable medium 600 may include one or more of a non-volatile memory, a volatile memory, and/or one or more storage devices. The volatile memory may be connected to a uninterruptable power supply.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 602 generally retrieves and executes the computer-implemented instructions stored in the non-transitory, computer-readable medium 600 for organizing a heterogeneous memory architecture. At block 604, a data module may add data blocks to non-volatile memory, which may include main memory and storage. At block 606, a parity module may add parity blocks to a fast, high endurance memory. The parity module may add first level parity or second level parity.

What is claimed is:

1. A system for organizing a heterogeneous memory architecture, comprising:
a processor that is adapted to execute stored instructions; and
a memory device that stores instructions, the memory device comprising processor-executable code, that when executed by the processor, is adapted to:
use a non-volatile storage to build a data block; and
use a fast, high endurance storage to build a corresponding parity block.

2. The system recited in claim 1, wherein the non-volatile storage is a non-volatile random access memory (NVRAM).

3. The system recited in claim 1, wherein the fast, high endurance storage is a dynamic random access memory (DRAM), static random access memory (SRAM), or other volatile memory.

4. The system recited of claim 1, wherein the fast, high endurance storage is supported with a backup battery or an uninterruptable power supply.

5. The system recited in claim 1, wherein the fast, high endurance storage maintains parity such that every parity block stores information relating to a few main memory devices and a larger number of storage devices.

6. The system recited in claim 1, wherein redundant information from a data word is stored in multiple parity words, wherein the data word is stored in the non-volatile storage and the multiple parity words are stored in the fast, high endurance storage.

7. The system recited in claim 1, wherein the fast, high endurance storage is used to build a second set of parity blocks corresponding to storage, wherein the non-volatile storage includes main memory and storage.

8. A method for organizing a heterogeneous memory architecture, comprising:
building data blocks in non-volatile memory; and
building corresponding parity blocks in a fast, high endurance memory.

9. The method recited in claim 8, wherein the non-volatile memory is non-volatile random access memory (NVRAM).

10. The method recited in claim 8, wherein the fast, high endurance memory is dynamic random access memory (DRAM), static random access memory (SRAM), or other volatile memory.

11. The method recited in claim 8, comprising supporting the fast, high endurance memory with backup battery power or an uninterruptable power supply.

12. The method recited in claim 8, wherein the fast, high endurance memory maintains parity such that every parity block stores information relating to a few main memory devices and a larger number of storage devices.

13. The method recited in claim 8, wherein redundant information from a data word is stored in multiple parity words, wherein the data word is stored in the non-volatile memory and the multiple parity words are stored in the fast, high endurance memory.

14. The method recited in claim 8, wherein the fast, high endurance memory is used to build a second set of parity blocks corresponding to storage, wherein the non-volatile memory includes main memory and storage.

15. A non-transitory, computer-readable medium, comprising code configured to direct a processor to:
build data blocks in non-volatile memory; and
build corresponding parity blocks in a fast, high endurance memory.

16. The non-transitory, computer-readable medium recited in claim 15, wherein the non-volatile memory is non-volatile random access memory (NVRAM), or the fast, high endurance memory is dynamic random access memory (DRAM), static random access memory (SRAM), or other volatile memory.

17. The non-transitory, computer-readable medium recited in claim 15, comprising supporting the fast, high endurance memory with backup battery power or an uninterruptable power supply.

18. The non-transitory, computer-readable medium recited in claim 15, wherein the fast, high endurance memory maintains parity such that every parity block stores information relating to a few main memory devices and a larger number of storage devices.

19. The non-transitory, computer-readable medium recited in claim 15, wherein redundant information from a data word is stored in multiple parity words, wherein the data word is stored in the non-volatile memory and the multiple parity words are stored in the fast, high endurance memory.

20. The non-transitory, computer-readable medium recited in claim 15, wherein the fast, high endurance memory is used to build a second set of parity blocks corresponding to storage, wherein the non-volatile storage includes main memory and storage.
